(19) United States
(12) Patent Application Publication
(10) Pub. No.: US 2022/0092828 A1
(43) Pub. Date: Mar. 24, 2022

(54) IMAGE PREVIEW USING OBJECT IDENTIFICATIONS

(71) Applicant: International Business Machines Corporation, Armonk, NY (US)

(72) Inventors: Lukasz Tomasz Jeda, Krakow (PL); Jacek Midura, Zabierzow (PL); Adam Babol, Lubartow (PL); Andrzej Pietrzak, Podleze (PL)

(21) Appl. No.: 17/027,845

(22) Filed: Sep. 22, 2020

(51) Int. Cl. G06T 11/00; G06T 7/70; G06K 9/00

(52) U.S. Cl. CPC G06T 11/00; G06T 7/70; G06K 9/00624; H04L 67/42; G06T 2210/22; G06T 2210/08; G06K 2209/27

(57) ABSTRACT

An image is requested from a server. A set of object identifications associated with the image is received from the server. At least a portion of the set of object identifications is determined to be associated with a set of local images. A preview is generated using the set of local images, and the preview is displayed to a user.

### BACKGROUND

The present disclosure relates generally to the field of media transfers, and more particularly to handling images.

File size of digital images and other media continues to increase as media quality increases. In turn, the bandwidth and resources required to transfer such media also increases. Thumbnail and/or low-resolution copies of the media have traditionally been used to show previews of the media to a user, and thereby reduce bandwidth consumption from user errors where the wrong media was downloaded blindly.

### SUMMARY

Embodiments of the present disclosure include a method, computer program product, and system for handling images.

An image is requested from a server. A set of object identifications associated with the image is received from the server. At least a portion of the set of object identifications is determined to be associated with a set of local images. A preview is generated using the set of local images, and the preview is displayed to a user.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates an example network environment for handling images, in accordance with embodiments of the present disclosure.

FIG. 2 illustrates an example image layout, in accordance with embodiments of the present disclosure.

FIG. 3 illustrates an example method for handling images, in accordance with embodiments of the present disclosure.

FIG. 4 depicts a cloud computing environment according to an embodiment of the present disclosure.

FIG. 5 depicts abstraction model layers according to an embodiment of the present disclosure.

FIG. 6 depicts a high-level block diagram of an example computer system that may be used in implementing embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of media transfers, and more particularly to handling images. While the present disclosure is not necessarily limited to such applications, various aspects of the disclosure may be appreciated through a discussion of various examples using this context.

Computer networks, and especially the Internet, are used to share information. A significant amount of this information is embodied in the form of media, such as audio, video, and image files. As technology advances, the quality and file size of the media improves and increases. In several circumstances, this may lead to noticeable loading times and a degree of inefficiency when media is sent to a device which already stores a copy of that particular media.

Traditional methods for preventing the redundant download of media may include the generation and display of a thumbnail preview (e.g., a lower resolution, but substantially similar copy) of an image stored on a server. In this way, a user may recognize an image or other piece of media prior to downloading it from the server.

Embodiments of the present disclosure contemplate a novel method for generating an image (or other media) preview without the need for generating a thumbnail or other preview from the media stored on the server. Rather, embodiments of the present disclosure call for an object recognition analysis of media files to identify, for example, objects within an image, the location of each identified object within the image, and the orientation of each object within the image.

In some embodiments, the objects identified may receive unique object identifications, and may be stored, as metadata annotated to the media itself and/or in a table or other data structure, to catalog the objects within a set or library of images or other media.

In some embodiments, when a request for a particular piece of media is sent to a server (e.g., a user wishes to download or display an image stored on a social media platform), the server may first send the metadata associated with the media to the requesting device, in order to either generate a preview using locally stored images, or to display a local copy of the requested image, if such a copy exists in the storage of the requesting device.

In some embodiments, a preview generated from locally stored images could be generated by identifying, using the object identifications and other metadata, local images that contain one or more of the objects identified by the object IDs. The objects in the local images may be cropped and spliced into a composite image to generate a preview image for the user. In this way, a preview may be generated without using network bandwidth and server resources. In some embodiments, the metadata may further indicate the location/coordinates at which each object should reside within the image preview, as well as an orientation (e.g., left-facing, right-facing, front-facing, rotated by 45 degrees clockwise, etc.) to provide an image preview that more closely resembles the requested image.

In some embodiments, such a method may determine that the requested image already resides in local storage (e.g., identical object IDs and metadata are associated with a local image). In such a circumstance, the image request may be canceled and the local image displayed, thereby reducing both the resources required to generate a preview, as well as any resources that would have been consumed by subsequently downloading the image from the server.

In some embodiments, object IDs could be assigned to a class of objects (e.g., a mountain, a car, a tree, a person, etc.), or it could be assigned to a unique, or nearly-unique object (e.g., Mount Rainier, a white PONTIAC GRAND AM, Old Juniper, an individual person, etc.) In yet other embodiments, an object could have multiple IDs associated with it. For example, a single object could have both a general ID (e.g., mountain) and a specific ID (e.g., Mount Rainier). In this way, a preview, or composite image, may be generated using the most similar objects available in the storage of a requesting device.

In some embodiments, the associated metadata (e.g., location coordinates, orientation information) may be used to place locally stored objects into the proper position and orientation within the generated composite image. This may include, for example, resizing objects, rotating object, flipping objects, and positioning objects according to a coordinate, or, in some embodiments, according to relative distance among the objects.

In this way, a preview of an image or other piece of media could be generated, where the preview, while possibly not as accurate as a traditional thumbnail preview, still conveys enough visual information for a user to recognize/identify the image and decide, if no local copy is found, whether to download the image/media or not. In some embodiments, the user may be notified, in some fashion, that the preview/composite image is not a thumbnail copy of the requested image. For example, in some embodiments, the generated preview may have a colored border, may include an asterisk or other symbol, may be accompanied by a popup, etc.

Using this method, network bandwidth and other resources may be preserved, thereby reducing the likelihood that, for example, a user will exceed a bandwidth threshold (e.g., on a mobile device with a monthly bandwidth restriction).

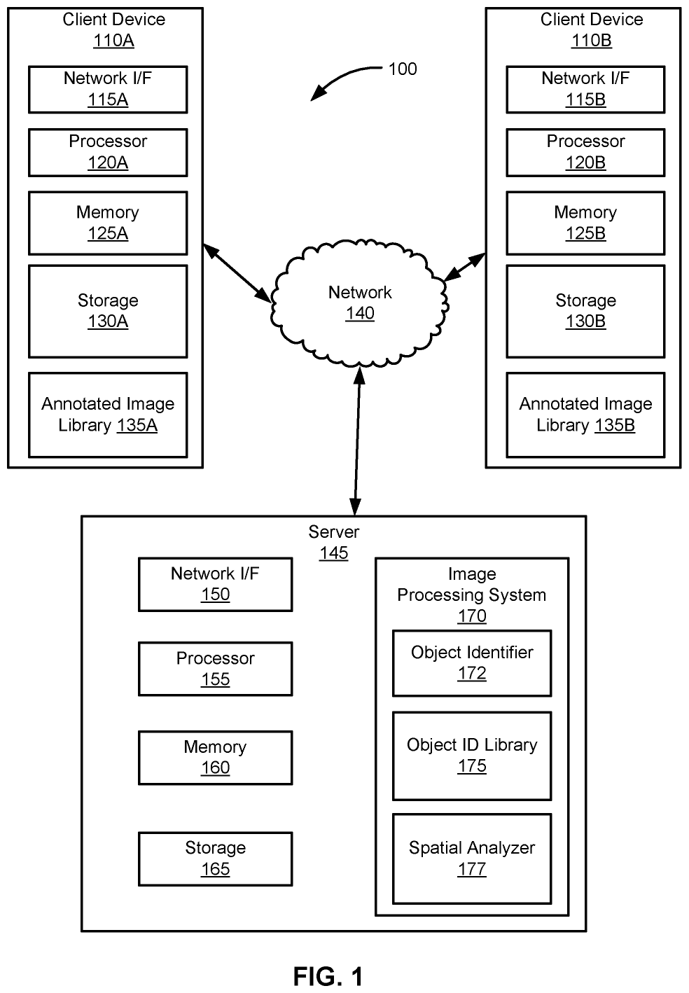

Referring now to FIG. 1, illustrated is an example network environment 100 for handling images, in accordance with embodiments of the present disclosure. In embodiments, the example network environment 100 may include client devices 110A-B, network 140, and server 145. In some embodiments, certain functions of client devices 110A-B and server 145 may be implemented at a location different from the depiction.

According to embodiments, the server 145 and the client devices 110A-B may be computer systems. The client devices 110A-B and the server 145 may include one or more processors 120A-B and 155 and one or more memories 125A-B and 160, respectively. The client devices 110A-B and the server 145 may be configured to communicate with each other through an internal or external network interfaces 115A-B and 150. The network interfaces 115A-B and 150 may be, e.g., modems, wireless network adapters, Ethernet adapters, etc. The client devices 110A-B and/or the server 145 may be equipped with a display or monitor. Additionally, the client devices 110A-B and/or the server 145 may include optional input devices (e.g., a keyboard, mouse, scanner, or other input device), and/or any commercially available or custom software (e.g., image processing software, object identification software, etc.). In some embodiments, the client devices 110A-B and/or the server 145 may be servers, desktops, laptops, or hand-held devices.

Client devices 110A-B and server 145 may further include storage 130A-B and 165, respectively. Storage 130A-B and 165 may include, for example, virtualized disk drives, physical hard disk drives, solid state storage drives, or any other suitable storage media. In embodiments, media, images, and the object identifications and metadata may be stored using storage 130A-B and 165.

The client devices 110A-B and the server 145 may be distant from each other and may communicate over a network 140. In embodiments, the server 145 may be a central hub from which client devices 110A-B and other remote devices (not pictured) can establish a communication connection, such as in a client-server networking model. In some embodiments, the server 145 and client devices 110A-B may be configured in any other suitable network relationship (e.g., in a peer-to-peer configuration or using another network topology).

In embodiments, the network 140 can be implemented using any number of any suitable communications media. For example, the network 140 may be a wide area network (WAN), a local area network (LAN), the Internet, or an intranet. In certain embodiments, the client devices 110A-B and the server 145 may be local to each other and communicate via any appropriate local communication medium. For example, the client devices 110A-B and the server 145 may communicate using a local area network (LAN), one or more hardwire connections, a wireless link or router, or an intranet. In some embodiments, client devices 110A-B and the server 145, and any other devices may be communicatively coupled using a combination of one or more networks and/or one or more local connections. For example, the client devices 110A-B may be hardwired to the server 145 (e.g., connected with an Ethernet cable) while a third client device (not pictured) may communicate with the host device using the network 140 (e.g., over the Internet).

In some embodiments, the network 140 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 140.

In some embodiments, server 145 may store, or otherwise have access to, a set of media, including images. Server 145 may utilize image processing system 170 to generate the object IDs and other metadata contemplated by this disclosure. Image processing system may include, for example, object identifier 172, object ID library 175, and spatial analyzer 177. In some embodiments, object ID library may reside within storage 165.

Object identifier 172 may ingest video frames and other images and, using object recognition techniques (e.g., facial recognition, landmark recognition, GPS metadata, object recognition, street recognition, building recognition, etc.) may generate object IDs for the objects identified within the image. In some embodiments, an object within a particular image may have already been identified in other images, and so the same object ID may be associated, as opposed to newly generated, with the object in the image. In some embodiments, multiple object IDs of varying levels of specificity may be assigned to the same object, as described herein.

Persons having skill in the art may appreciate that spatial analyzer 177 may be included with object identifier 172, or it may be separate. Spatial analyzer 177 may generate metadata for association with the object IDs. Metadata may include, for example, coordinates for determining the location of an object within an image, orientation information regarding the rotation and other orientation information of an object, object sizing, etc.

Object ID Library 175 may include a table or other suitable data structure for storing the object IDs and metadata, as well as the associations to particular media files. In this way, the server 145 may track which objects reside within each image/medium, and, upon a request for a particular medium/image, send the associated object ID and metadata to a requesting device, such as client devices 110A-B.

Client devices may include annotated image library 135A-B, respectively. In some embodiments, annotated image library 135A-B may include at least a portion of the images locally stored on client devices 110A-B, respectively. Annotated image library 135A-B may further include, for example, a list of object IDs for each of the locally stored images. In this way, client devices 110A-B may determine, in response to receiving a set of object IDs from server 145, whether a preview may be generated from locally stored images within annotated image library 135A-B, respectively.

While FIG. 1 illustrates example network environment 100 with a single server 145 and two client devices 110A-B, suitable network environments for implementing embodiments of this disclosure may include any number of client devices and/or servers. The various models, modules, systems, and components illustrated in FIG. 1 may exist, if at all, across a plurality of devices. For example, some embodiments may include two client devices or two servers. The hypothetical two servers may be communicatively coupled using any suitable communications connection (e.g., using a WAN, a LAN, a wired connection, an intranet, or the Internet). The first server may include spatial analyzer 177, and the second server may include the remainder of the image processing system 170. In such embodiments, the various servers may communicate and act in concert to execute the functions of the disclosure.

It is noted that FIG. 1 is intended to depict the representative major components of an example network environment 100. In some embodiments, however, individual components may have greater or lesser complexity than as represented in FIG. 1; components other than or in addition to those shown in FIG. 1 may be present, and the number, type, and configuration of such components may vary.

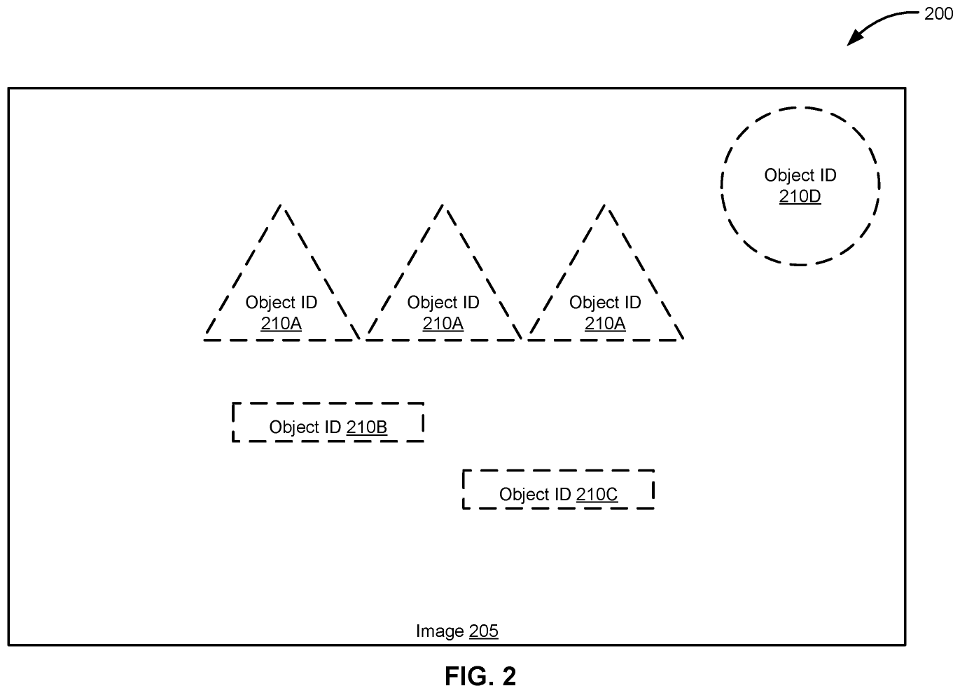

Referring now to FIG. 2, illustrated is an example image layout 200, in accordance with embodiments of the present disclosure. In some embodiments, example image layout 200 may include image 205 and object IDs 210A-D.

In some embodiments, image 205 may depict a requested image residing on server 145, or it may depict a composite image generated at client devices 110A-B. Image 205 may include any number of objects, and each object may have an object ID associated therewith. For example, object ID 210A may be associated with a mountain. In this example, image 205 contains three mountains, indicated with three copies of object ID 210A.

In some embodiments, object ID 210D may be associated with the sun, the moon, an aircraft, a cloud, etc. Object IDs 210B-C may be associated with a tree, a person, a vehicle, a building, or any other identifiable object.

In some embodiments, each object ID 210A-D may further include, or be associated with sizing, orientation, and coordinate/location metadata such that a preview/composite for image 205 may be generated in a fashion that resembles a requested image (e.g., an image requested from server 145). In this way, a preview of an image or video frame may be generated locally on client device(s) 110A-B by identifying locally stored images which contain at least some of the objects associated with object IDs 210A-D, cropping them from the locally stored images, and merging them, according to the metadata information, into a composite image that resembles the requested image.

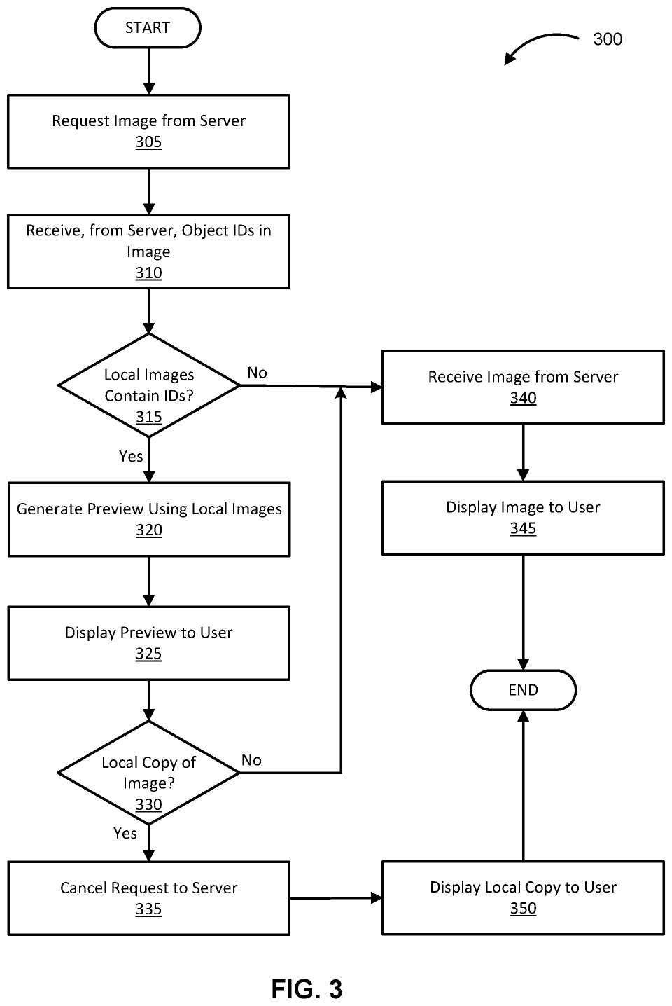

Referring now to FIG. 3, illustrated is an example method 300 for handling images, in accordance with embodiments of the present disclosure. In some embodiments, example method 300 may begin at 305, where an image is requested from a server. In some embodiments, the image may include one or more frames of a video file.

At 310, a set of object IDs associated with objects identified in the request image is received from the server. In some embodiments, the object IDs may be generated by the server in real time, or they may have been pre-generated and stored.

At 315, it is determined whether any local images, or objects within the local images, are associated with any of the object IDs received from the server. For example, annotated image library 135A-B, or a table/data structure storing object IDs, may be searched to identify one or more locally stored images and/or the objects depicted within the locally stored image(s). In some embodiments, the determination at 315 may further consider whether one or more local images is/are associated with a sufficient number/type of object IDs. In some embodiments, there may be a threshold or set of criteria (not pictured) used to determine whether the number/type of object IDs is sufficient. For example, it may be sufficient if 80% of the received object IDs reside within the set of locally stored images. In some embodiments, some object IDs may have greater weight. For example, a specific object ID, as described herein, may hold more weight than a generic object ID, and the number/type of object IDs present in the locally stored images may be used to determine sufficiency.

If it is determined, at 315, no locally stored images are associated with the received object IDs, the requested image is received, or downloaded, from the server at 340, and the image is displayed to the user at 345.

If, however, it is determined, at 315, that local images exist which are associated with the set of received object IDs, a preview may be generated using those local images at 320. For example, the objects corresponding to the object IDs may be cropped from the local images and reassembled/merged into a composite image. In such embodiments, metadata associated with the object IDs may be used to resize, orient, and place each object within the composite image.

At 325, the preview is displayed to a user. This may include, as discussed herein, some indication that the generated preview is a composite image and may not be as accurate as a traditional thumbnail preview. In some embodiments, any image space between/among the identified objects may be left blank.

At 330, it may be determined whether a copy of the requested image resides in local storage. For example, if every received object ID and the associated metadata matches the object IDs and metadata associated with a single locally stored image, the locally stored image may be considered a copy of the requested image.

If it is determined, at 330, that no local copy of the requested image exists, and the user still wishes to download/view the requested image, the method may proceed to 340 and received the requested image from the server.

If, however, it is determined, at 330, that a local copy of the image exists, the original request to the server (step 305) may be interrupted/canceled at 335, and the local copy may be displayed to the user at 350. In this way, a redundant download of the requested image may be prevented, thereby preserving bandwidth and resources.

It is to be understood that although this disclosure includes a detailed description on cloud computing, implementation of the teachings recited herein are not limited to a cloud computing environment. Rather, some embodiments of the present invention are capable of being implemented in conjunction with any other type of computing environment now known or later developed.

Cloud computing is a model of service deliver for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

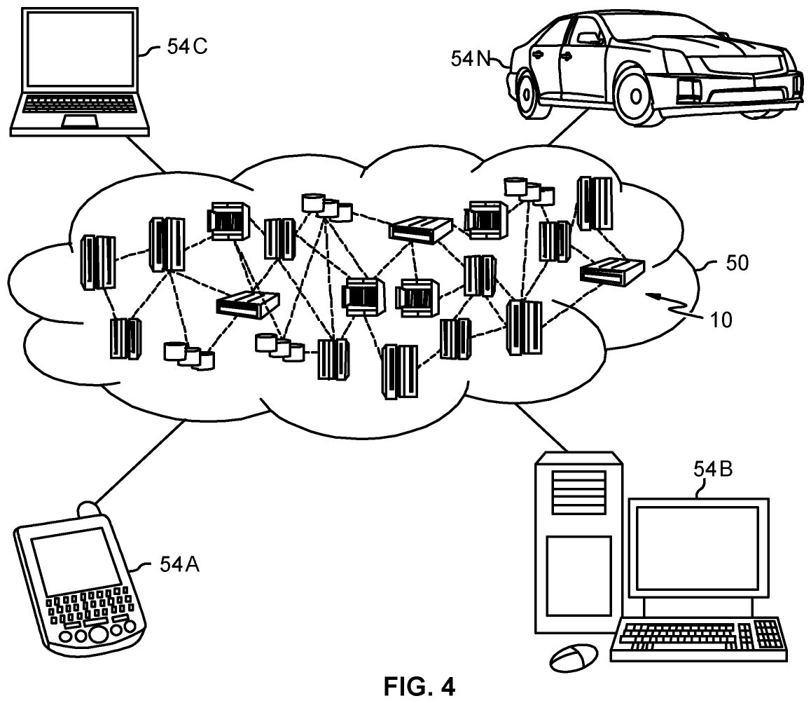

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

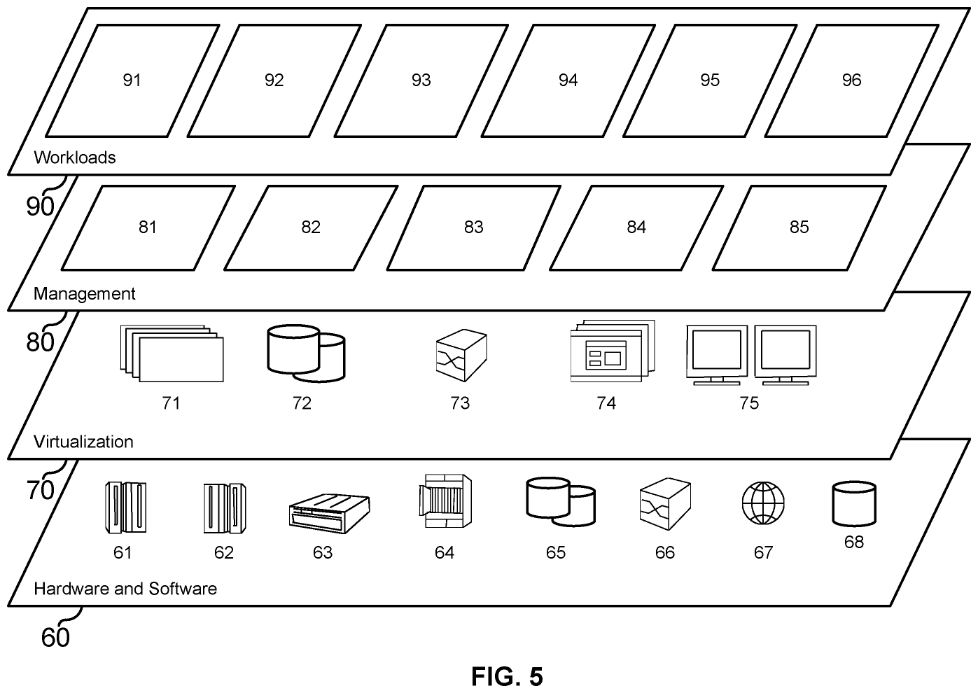

Referring now to FIG. 5, a set of functional abstraction layers provided by cloud computing environment 50 (FIG. 4) is shown. It should be understood in advance that the components, layers, and functions shown in FIG. 5 are intended to be illustrative only and some embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and image previewing 96.

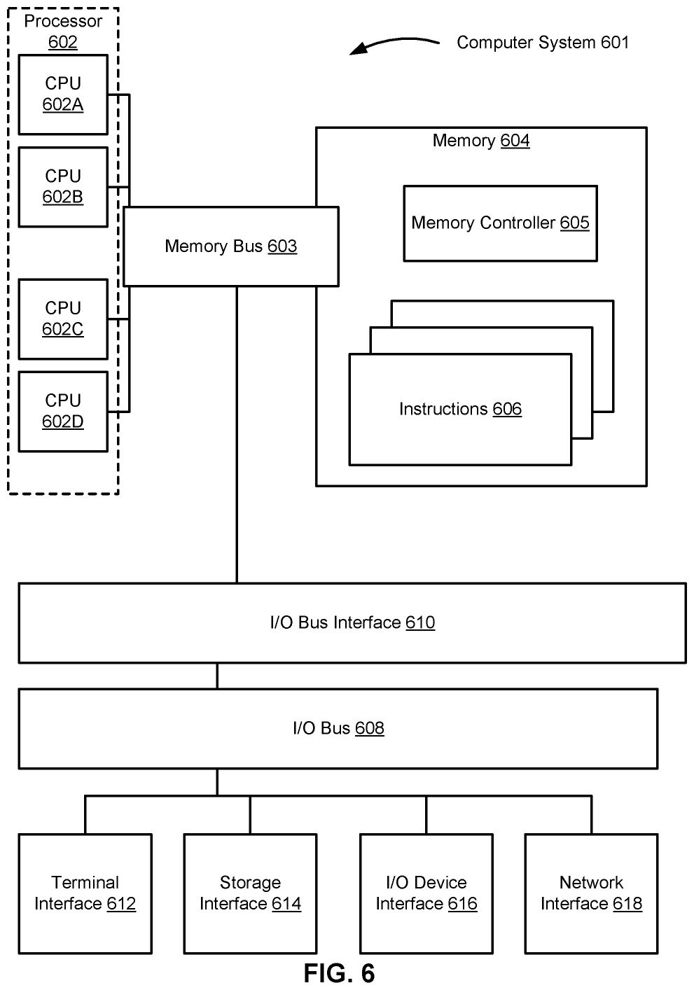

Referring now to FIG. 6, shown is a high-level block diagram of an example computer system 601 that may be configured to perform various aspects of the present disclosure, including, for example, method 300, described in FIG. 3. The example computer system 601 may be used in implementing one or more of the methods or modules, and any related functions or operations, described herein (e.g., using one or more processor circuits or computer processors of the computer), in accordance with embodiments of the present disclosure. In some embodiments, the illustrative components of the computer system 601 comprise one or more CPUs 602, a memory subsystem 604, a terminal interface 612, a storage interface 614, an I/O (Input/Output) device interface 616, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may comprise one or more levels of on-board cache. Memory subsystem 604 may include instructions 606 which, when executed by processor 602, cause processor 602 to perform some or all of the functionality described above with respect to FIG. 3.

In some embodiments, the memory subsystem 604 may comprise a random-access semiconductor memory, storage device, or storage medium (either volatile or non-volatile) for storing data and programs. In some embodiments, the memory subsystem 604 may represent the entire virtual memory of the computer system 601 and may also include the virtual memory of other computer systems coupled to the computer system 601 or connected via a network. The memory subsystem 604 may be conceptually a single monolithic entity, but, in some embodiments, the memory subsystem 604 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 604 may contain elements for control and flow of memory used by the CPU 602. This may include a memory controller 605.

Although the memory bus 603 is shown in FIG. 6 as a single bus structure providing a direct communication path among the CPUs 602, the memory subsystem 604, and the I/O bus interface 610, the memory bus 603 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, mobile device, or any other appropriate type of electronic device.

It is noted that FIG. 6 is intended to depict the representative example components of an exemplary computer system 601. In some embodiments, however, individual components may have greater or lesser complexity than as represented in FIG. 6, components other than or in addition to those shown in FIG. 6 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for handling images, the method comprising:
requesting, by a client device, an image from a remote server;
receiving, by the client device and from the remote server, solely a set of object identifications associated with the image in response to the requesting of the image;
determining, by the client device, at least a portion of the set of object identifications is associated with a set of locally stored images that are stored on the client device;
generating, by the client device, a preview of the image using the set of locally stored images; and
displaying, by the client device, the preview to a user.

2. The method of claim 1, further comprising:
receiving, from the remote server, the image; and
displaying the image to the user.

3. The method of claim 1, further comprising:
determining, based on the set of object identifications, the set of locally stored images includes a copy of the image;
canceling the request for the image from the remote server; and
displaying the copy of the image to the user.

4. The method of claim 1, wherein:
each image within the set of locally stored images includes a set of metadata, the set of metadata including one or more object identifications representing a set of objects depicted within the respective image; and
each of the one or more object identifications is further associated with a coordinate representing a location within the respective image where the object appears.

5. (canceled)

6. The method of claim 4, wherein:
each of the one or more object identifications is further associated with an orientation representing the orientation of the object within the respective image; and
the preview is generated by cropping out the objects from the set of locally stored images and arranging them, according to location and orientation, into the preview.

7. (canceled)

8. A computer program product for handling images, the computer program product comprising a non-transitory computer readable storage medium having program instructions embodied therewith, the program instructions executable by a device to cause the device to:
request, by a client device, an image from a remote server;
receive, by the client device and from the remote server, solely a set of object identifications associated with the image in response to the request of the image;
determine, by the client device, at least a portion of the set of object identifications is associated with a set of locally stored images that are stored on the client device;
generate, by the client device, a preview of the image using the set of locally stored images; and
display, by the client device, the preview to a user.

9. The computer program product of claim 8, wherein the program instructions further cause the device to:
receive, from the remote server, the image; and
display the image to the user.

10. The computer program product of claim 8, wherein the program instructions further cause the device to:
determine, based on the set of object identifications, the set of locally stored images includes a copy of the image;
cancel the request for the image from the remote server; and
display the copy of the image to the user.

11. The computer program product of claim 8, wherein each image within the set of locally stored images is associated with a set of metadata, the set of metadata including one or more object identifications representing a set of objects depicted within the respective image.

12. The computer program product of claim 11, wherein;
each of the one or more object identifications is further associated with a coordinate representing a location within the respective image where the object appears; and
each of the one or more object identifications is further associated with an orientation representing the orientation of the object within the respective image.

13. (canceled)

14. The computer program product of claim 12, wherein the preview is generated by cropping out the objects from the set of locally stored images and arranging them, according to location and orientation, into a composite image for the preview.

15. A system for handling images, the system comprising:
a memory subsystem, with program instructions included thereon; and
a processor in communication with the memory subsystem, wherein the program instructions cause the processor to:
request, by a client device, an image from a remote server;
receive, by the client device and from the remote server, solely a set of object identifications associated with the image in response to the request of the image;
determine, by the client device, at least a portion of the set of object identifications is associated with a set of locally stored images that are stored on the client device;
generate, by the client device, a preview of the image using the set of locally stored images; and
display, by a client device, the preview to a user.

16. The system of claim 15, wherein the program instructions further cause the processor to:
receive, from the remote server, the image; and
display the image to the user.

17. The system of claim 15, wherein the program instructions further cause the processor to:
determine, based on the set of object identifications, the set of locally stored images includes a copy of the image;
cancel the request for the image from the remote server; and
display the copy of the image to the user.

18. The system of claim 15, wherein each image within the set of locally stored images is associated with a set of metadata, the set of metadata including one or more object identifications representing a set of objects depicted within the respective image.

19. The system of claim 18, wherein each of the one or more object identifications is further associated with a coordinate representing a location within the respective image where the object appears.

20. The system of claim 19, wherein the preview is generated by cropping out the objects from the set of locally stored images and arranging them, according to location, into a composite image for the preview.

21. The method of claim 1, further comprising:
calculating a percentage of the portion of the set of object identifications with respect to a totality of the set of object identifications; and
comparing the percentage to a threshold;
wherein generating the preview of the image using the set of locally stored images only occurs in response to the percentage satisfying the threshold.

22. The method of claim 1, wherein generating the preview is performed solely using the set of locally stored images.

23. The method of claim 1, further comprising displaying a notification that the preview is not a lower resolution version of the image.
